(19) United States
(12) Patent Application Publication
(10) Pub. No.: US 2011/0028207 A1
(43) Pub. Date: Feb. 3, 2011

(54) INTEGRATING VIDEO BROADCASTS INTO WAGERING GAMES

(76) Inventors: Mark B. Gagner, West Chicago, IL (US); Damon E. Gura, Chicago, IL (US); Jeremy M. Hornik, Chicago, IL (US); Joel R. Jaffe, Glenview, IL (US)

Correspondence Address: WMS GAMING (DELIZIO GILLIAM);C/O DELIZIO GILLIAM, PLLC, 15201 MASON ROAD, SUITE 1000-312, CYPRESS, TX, 77433, US

(21) Appl. No.: 12/935,787

(22) PCT Filed: Mar. 30, 2009
(86) PCT No.: PCT/US2009/038801

§ 371 Date: Sep. 30, 2010

Related U.S. Application Data
(60) Provisional application No. 61/041,006, filed on Mar. 31, 2008.

(51) Int. Cl. A63F 9/24; A63F 13/00

(52) U.S. Cl. 463/25; 463/30; 463/43; 463/42

(57) ABSTRACT

Described herein are processes and devices that integrate video broadcasts into wagering games. One of the devices described is a wagering game system. The wagering game system can receive a video feed and detect activity performed in the video feed. The system can generate a wagering game character that in some way emulates the activity performed in the video feed. The system can detecting activities performed by the wagering game character and utilize the activities to generating a wagering game outcome. The system can also generate overlay objects to be used as wagering game elements and integrate the overlay objects with the video feed as a wagering game, or in conjunction with wagering games.

### RELATED APPLICATIONS

This application claims the priority benefit of U.S. Provisional Application Ser. No. 61/041,006 filed Mar. 31, 2008.

### LIMITED COPYRIGHT WAIVER

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2009, WMS Gaming, Inc.

### TECHNICAL FIELD

Embodiments of the inventive subject matter relate generally to wagering game systems, and more particularly to devices and processes that integrate video broadcasts into wagering games of wagering game systems and networks.

### BACKGROUND

Wagering game machines, such as slot machines, video poker machines and the like, have been a cornerstone of the gaming industry for several years. Generally, the popularity of such machines depends on the likelihood (or perceived likelihood) of winning money at the machine and the intrinsic entertainment value of the machine relative to other available gaming options. Where the available gaming options include a number of competing wagering game machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for wagering game machine manufacturers to continuously develop new games and gaming enhancements that will attract frequent play.

### SUMMARY

In some embodiments, a method comprises receiving a video feed; detecting a video feed game activity performed in the video feed by a video feed performer; generating a wagering game character configured to emulate the activity of the video feed performer; detecting a wagering game activity performed by the wagering game character; and generating a wagering game outcome based on the wagering game activity performed by the wagering game character.

In some embodiments, the video feed is any one or more of a live television broadcast, a recorded television broadcast, and an internet broadcast.

In some embodiments, detecting the video feed game activity comprises: determining information about the video feed game activity, wherein the information comprises any one or more of game rules, video themes, item movements, and game statistics; and utilizing the information to generate a wagering game scenario in which to present the wagering game activity, wherein the wagering game scenario appears and behaves similar to the video feed game activity.

In some embodiments, the method further comprises presenting the video feed and the wagering game activity as a single multimedia presentation.

In some embodiments, the presenting comprises: tracking the video feed game activity until the video feed performer completes a game turn; pausing the video feed after the video feed performer completes the turn so the wagering game character can perform the wagering game activity; and resuming the video feed on the wagering game machine after the wagering game character has completed the wagering game activity.

In some embodiments, the method further comprises inviting one or more wagering game player accounts to participate in the wagering game activity.

In some embodiments, one or more machine-readable media having instructions stored thereon, which when executed by a set of one or more processors causes the set of one or more processors to perform operations that comprise receiving a video feed; generating one or more overlay objects to be positioned on the video feed as wagering game elements; integrating the one or more overlay objects with the video feed; and processing the overlay objects as wagering game elements.

In some embodiments, the video feed is any one of more of a live television broadcast, a recorded video broadcast, and a casino generated video feed.

In some embodiments, generating the one or more overlay objects comprises detecting one or more video items that appear on the video feed; and generating the one or more overlay objects to conform to geometric shapes of the one or more video items.

In some embodiments, the overlay objects can be any one or more of an animation, an outline, a border, a visual effect, and a virtualized object.

In some embodiments, the integrating comprises: accessing a player account with a player preference for displaying the one or more overlay objects; and presenting the one or more overlay objects according to the player preference.

In some embodiments, processing the overlay objects comprises detecting a selection of an overlay object; determining a wagering game outcome related to the selected overlay object; and presenting the wagering game outcome.

In some embodiments, a system comprises a wagering game server comprises a video feed integrator configured to receive a video feed, and generate wagering game elements that relate to the video feed, and a content controller configured to process the wagering game elements as a wagering game; and a wagering game machine comprising a video integration module configured to integrate the wagering game elements with the video feed in the wagering game, and present the wagering game on a wagering game machine display.

In some embodiments, the video feed integrator is further configured to generate a virtual character configured to emulate game activity of a video feed character in the video feed.

In some embodiments, the video feed integrator is further configured to detect thematic elements of the video feed, and generate the wagering game elements to conform to the thematic elements in any one or more of behavior and appearance.

In some embodiments, the system further comprises an overlay generator configured to generate one or more overlay objects configured as game play elements, and integrate the one or more overlay objects with the video feed.

In some embodiments, the content controller is further configured to detect wagering game activity performed by the wagering game elements, and generate a wagering game outcome based on the wagering game activity.

In some embodiments, the system further comprises an account server configured to invite player accounts to participate in the wagering game, and store player preferences regarding how the wagering game elements are presented.

In some embodiments, an apparatus, comprises a video feed integrator configured to receive a video feed, and detect one or more video items that appear on the video feed; an overlay generator configured to generate one or more overlay objects, and superimpose the one or more overlay objects onto the video feed to highlight the location of the one or more video items; and a video integration module configured to process the overlay objects as wagering game elements.

In some embodiments, the video feed integrator is further configured to determine a background of the video feed in relation to the position of the one or more video items, and detect any one or more of the locations, shapes, patterns, and movements of the one or more video items.

In some embodiments, the overlay generator is further configured to determine a number of game play objects needed to process a wagering game, according to wagering game logic and generate the number of needed overlay objects.

In some embodiments, the overlay generator is further configured to generate overlay objects that include any one or more of an animation similar to the appearance of the one or more video items, an outline effect surrounding the one or more video items, and a visual effect emanating from the one or more video items.

In some embodiments, the video integration module is further configured to process the one or more overlay objects using any one or more of pattern recognition algorithms, grid coordinate tracking, virtual reality gear, top boxes, and peripheral display devices.

In some embodiments, a wagering game machine comprises means for displaying a presentation of a television broadcast feed on a wagering game machine display; means for detecting a television game activity performed in the video feed by a television character; means for pausing the presentation of the television broadcast feed on the wagering game machine display; means for presenting a wagering game character configured to emulate the activity of the television character; means for detecting wagering game activity performed by the wagering game character; means for presenting a wagering game outcome based on the wagering game activity performed by the wagering game character; and means for resuming the presentation of the television broadcast feed on the wagering game machine display.

In some embodiments, the means for presenting the wagering game outcome further comprises means for generating a wagering game character statistics; and means for presenting the wagering game character statistics with a television character statistics.

### BRIEF DESCRIPTION OF THE DRAWING(S)

Embodiments are illustrated in the Figures of the accompanying drawings in which:

FIG. 1 is an illustration of a wagering game system 100, according to some embodiments;

FIG. 2 is an illustration of utilizing account preferences with video based wagering games, according to some embodiments;

FIG. 3 is an illustration of a wagering game system architecture 300, according to some embodiments;

FIG. 4 is a flow diagram 400 illustrating generating and integrating overlay objects on a video feed in a wagering game, according to some embodiments;

FIG. 5 is a flow diagram 500 illustrating generating and presenting wagering game scenarios that emulate activity from a video feed, according to some embodiments;

FIG. 6 is an illustration of a wagering game machine architecture 600, according to some embodiments; and

FIG. 7 is an illustration of a mobile wagering game machine 700, according to some embodiments.

### DESCRIPTION OF ILLUSTRATIVE EMBODIMENTS

This description of the embodiments is divided into six sections. The first section provides an introduction to embodiments. The second section describes example operating environments while the third section describes example operations performed by some embodiments. The fourth section describes additional example embodiments while the fifth section describes additional example operating environments. The sixth section presents some general comments.

### INTRODUCTION

This section provides an introduction to some embodiments.

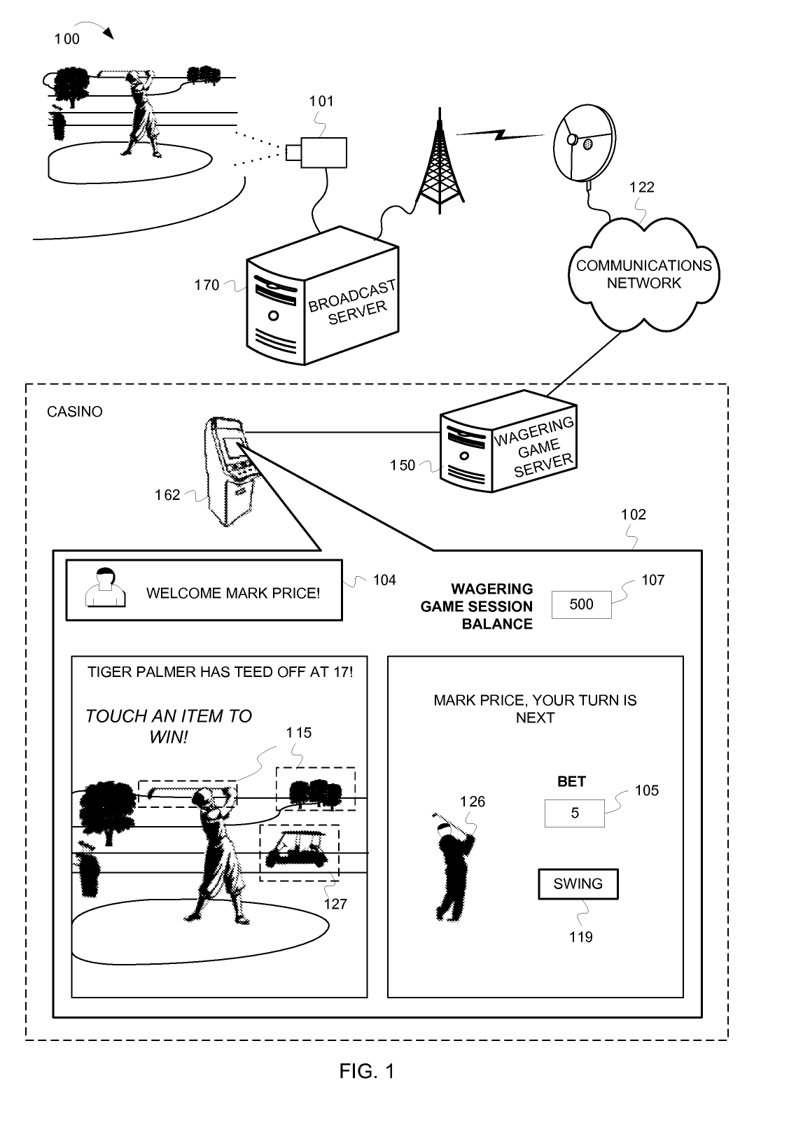

Wagering game providers constantly create a variety of fun and interesting wagering games. Those wagering games present wagering game content (e.g., background images, wagering game elements, animations, reel images, cartoon characters, etc.) to provide an interesting theme to the wagering game to engage the wagering game player. That content has traditionally been restricted to simple content files (e.g., static images, game animations, etc.) that can be stored and accessed locally on a casino network. By restricting wagering game content to simple content stored on the casino network, the wagering game providers can maximize the ability for the wagering game machine and server to interact and present the content to the wagering game player without significant delays. However, as wagering game machines and servers become more powerful in their ability to process and utilize all kinds of information, wagering game providers are discovering new ways to expand potential sources of wagering game content. FIG. 1 shows a wagering game system that can obtain wagering game content from sources outside of a typical casino network and manipulate the content to function as a wagering game.

FIG. 1 is a conceptual diagram that illustrates an example of a wagering game system 100, according to some embodiments. In FIG. 1, the system can receive a video feed (e.g., a live television broadcast, a recorded video of a movie, a personal home video, a casino generated video clip, etc.). The video feed can originate from a broadcast server 170 that processes, stores, and/or transmits video captures by a video camera 101. The broadcast server 170 can transmit the video feed via a communications network 122. A wagering game server 150 can receive the video feed and integrate the video feed as part of a wagering game. The wagering game, with the integrated video feed, can be referred to as a “video-feed-integrated” or “video based” wagering game.

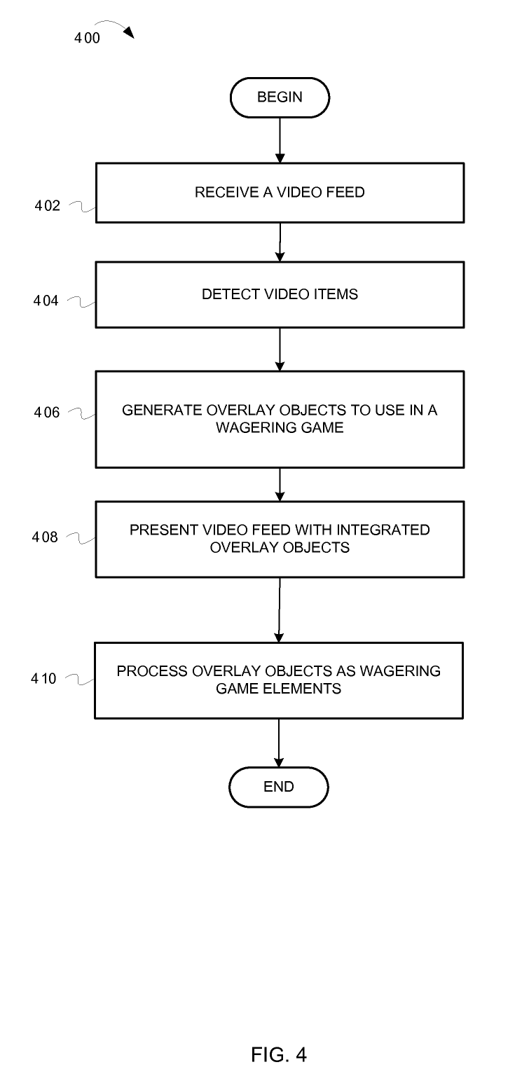

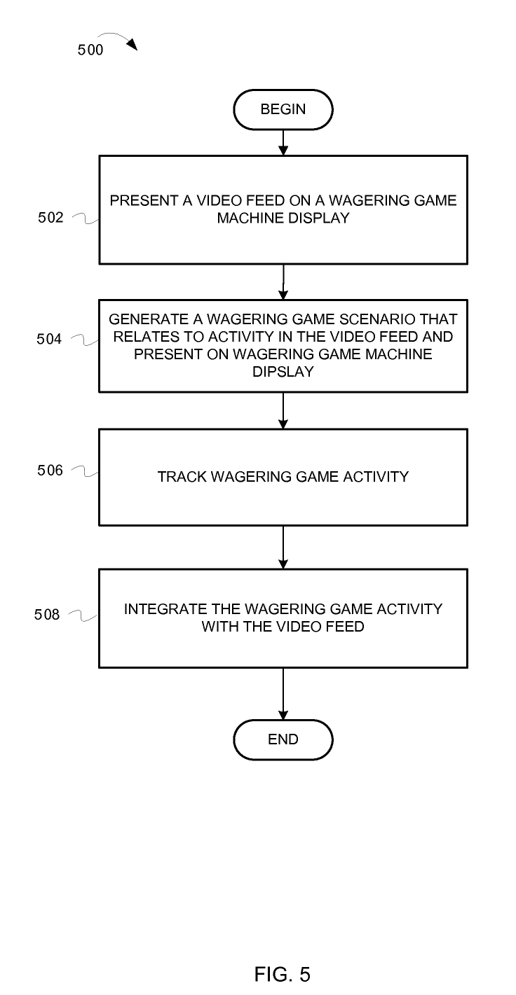

A wagering game machine 162 can login a wagering game player to a wagering game player account 104. The player account 104 can supply funds to a wagering game session. The wagering game machine 162 can have a display 102 to present player information, session credit balances 107, wagering game meters (e.g., bet meter 105), wagering game controls (e.g., button 119), and wagering game play elements. The system 100 can also display all or part of the video feed as part of the wagering game on the display 102. For example, the system 100 can present overlay objects 115, 127 on top of the video feed. The overlay objects 115, 127 can represent game play elements that the player can select. The system 100 can generate wagering game outcomes when a player selects one of the overlay objects 115, 127. FIG. 4 below describes an example flow of generating and presenting overlay objects with a video feed. The system 100 can also present a wagering game that emulates activities and/or themes presented in the video feed. The system 100 can use the activity and/or themes to present a wagering game scenario that a wagering game player can participate in. The wagering game scenario can relate to the activity of the video feed. For instance, the system 100 can analyze the activities or items appearing in the video feed. The system 100 can then generate a wagering game scenario based on the activities or items. For instance, the system 100 can create a wagering game that matches the look and feel of a golfing event, and create a virtual golf character 126 that the wagering game player can use in the wagering game. The system 100 presents controls (e.g., the button 119) that the wagering game player can use to participate in a virtualized representation of the sporting event as a wagering game. The system 100 can pause the video feed, detect the selection of the button 119, and present a wagering game based on a golfing scenario, where the virtual character 126 can perform generated activities resulting in a wagering game result (e.g., the system 100 could randomly generate a chance result for the virtualized golf ball to perform, resulting in a randomly generated wagering game outcome). FIG. 5 describes an example flow of generating and presenting wagering game scenarios that emulate activity from the video feed.

Although FIG. 1 describes some embodiments, the following sections describe many other features and embodiments.

### Example Operating Environments

This section describes example operating environments and networks and presents structural aspects of some embodiments. More specifically, this section includes discussion about wagering game systems and wagering game system architectures.

### Utilizing Account Preferences with Video Based Wagering Games

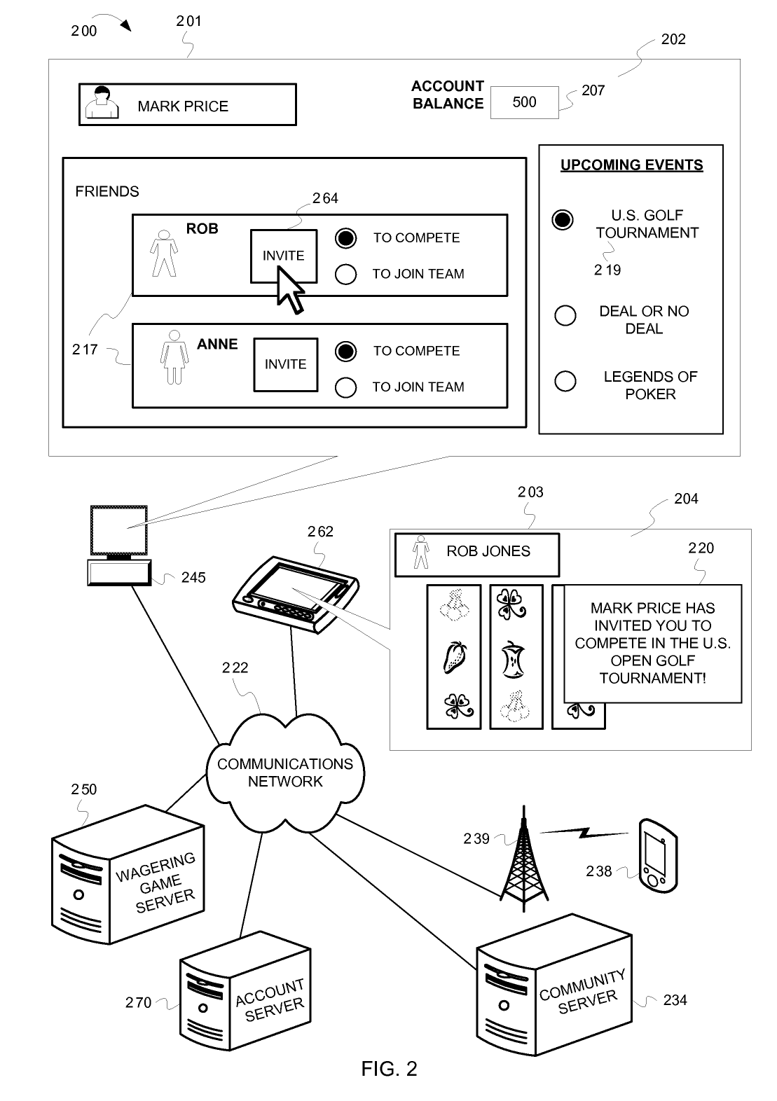

FIG. 2 is a conceptual diagram that illustrates an example of utilizing account preferences and settings with video based wagering games, according to some embodiments. In FIG. 2, the system 200 can integrate social contacts with video based wagering games. For example, the system 200 can invite a wagering game player's social contacts to compete in or join video based wagering games. In FIG. 2, the system 200 includes a computer 245 connected to a communications network 222. Also connected to the communications network 222 are a wagering game machine 262, a wagering game server 250, an account server 270, a community server 234, a broadcast device 239 and a wireless device 238. The computer 245 can login a user to a social-network account on the community server 234. The community server 234 can connect to an account 202 on the account server 270, which can store both social-network account information and wagering game account information. The account server 270 can present the information to the computer 245 to present on a display 201. The display 201 can present financial information (e.g., an account balance 207), player information, and information related to social contacts 217. The social contacts 217 can be friends, family, or other acquaintances that also have accounts on the account server 270. The system 200 can display potential events 219 that can be related to video based wagering games. The account owner can invite the social contacts 217, using control buttons 264, to participate in the video based wagering games. For instance, a video based wagering game, like that shown in FIG. 1, can relate to sports events, game shows, or other activities that can accommodate multiple participants. Those participants can compete against each other at the activity of the video based game. The system 200 can display the events 219 in anticipation of group related competitions for the video based wagering games. The account owner for the account 202 can then invite the social contacts 217 to participate in the upcoming video based games using the system 200. The social contacts 217 can receive the invitations on various devices, such as on the wagering game machine 262, on the mobile device 238, via email, via cell phone, etc. The wagering game machine 262 can have a display 203 that presents information related to wagering games as well as information related to accounts. For instance, the wagering game machine 262 can login a second account 204 of a social contact. The wagering game machine 262 can also present an invitation notification display 220 indicating the invitation sent from the first account 202.

### Wagering Game System Architecture

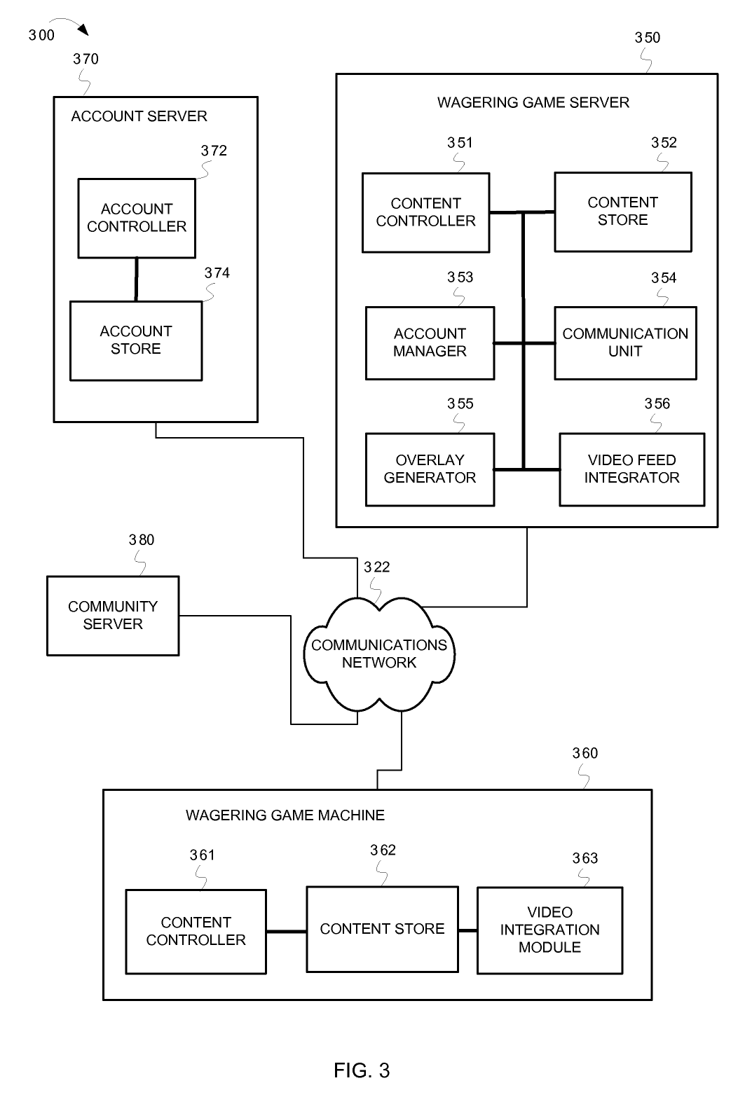

FIG. 3 is a conceptual diagram that illustrates an example of a wagering game system architecture 300, according to some embodiments. The wagering game system architecture 300 can include an account server 370 configured to control user related accounts accessible via wagering game networks and social networks. The account server 370 can store and track player information, such as identifying information (e.g., avatars, screen name, account identification numbers, etc.) or other information like financial account information, social contact information, etc. The account server 370 can contain accounts for social contacts referenced by the player account. The account server 370 can also provide auditing capabilities, according to regulatory rules, and track the performance of players, machines, and servers. The account server 370 can include an account controller 372 configured to control information for a player's account. The account server 370 also can include an account store 374 configured to store information for a player's account, including player preferences related to video based wagering games.

The wagering game system architecture 300 also can include a wagering game server 350 configured to control wagering game content and communicate wagering game information, account information, and video integration information to and from a wagering game machine 360. The wagering game server 350 can include a content controller 351 configured to manage and control content for the presentation of content on the wagering game machine 360. For example, the content controller 351 can generate game results (e.g., win/loss values), including win amounts, for games played on the wagering game machine 360. The content controller 351 can communicate the game results to the wagering game machine 360. The content controller 351 can also generate random numbers and provide them to the wagering game machine 360 so that the wagering game machine 360 can generate game results. The wagering game server 350 also can include a content store 352 configured to contain content to present on the wagering game machine 360. The wagering game server 350 also can include an account manager 353 configured to control information related to player accounts. For example, the account manager 353 can communicate wager amounts, game results amounts (e.g., win amounts), bonus game amounts, etc., to the account server 370. The wagering game server 350 also can include a communication unit 354 configured to communicate information to the wagering game machine 360 and to communicate with other systems, devices and networks. The wagering game server 350 also can include an overlay generator 355 configured to generate overlay objects that can be integrated with a video feed to make a video based wagering game. The wagering game server 350 also can include a video feed integrator 356 configured to integrate video data (e.g., television video broadcast feeds) with wagering games. The video feed integrator 356 can analyze activity and/or themes that occur in a video feed and generate wagering game elements and scenarios that emulate those activities and/or themes.

The wagering game system architecture 300 also can include a wagering game machine 360 configured to present wagering games and receive and transmit information to integrate video broadcasts into wagering games. The wagering game machine 360 can include a content controller 361 configured to manage and control content and presentation of content on the wagering game machine 360. The wagering game machine 360 also can include a content store 362 configured to contain content to present on the wagering game machine 360. The wagering game machine 360 also can include a video integration module 363 configured to process communications, commands, or other information, where the processing can integrate video feeds into wagering games. The video integration module 363 can perform any function that any other system component can perform regarding integrating video feeds into wagering games, and/or process data and control information provided by any of the other system components.

The wagering game system architecture 300 also can include a community server 380 configured to store accounts related to social networks. Via a communications network 322, the community server 380 can access a casino account stored on the account server 370, and vice-versa. For example, the community account owner can login to the community server 380 and access the account server 370 to set user preferences. Further, the account server 370 can track invitations to video based wagering games and then communicate those invitations to the community server 380 to be viewed and/or used with the community account.

Each component shown in the wagering game system architecture 300 is shown as a separate and distinct element. However, some functions performed by one component could be performed by other components. For example, the video integration module 363 could integrate video feeds and generate overlay objects to be used in wagering games. Furthermore, the components shown may all be contained in one device, but some, or all, may be included in, or performed by multiple devices on the systems and networks 322, as in the configurations shown in FIG. 3 or other configurations not shown. Furthermore, the wagering game system architecture 300 can be implemented as software, hardware, any combination thereof, or other forms of embodiments not listed. For example, any of the network components (e.g., the wagering game machines, servers, etc.) can include hardware and machine-readable media including instructions for performing the operations described herein. Machine-readable media includes any mechanism that provides (i.e., stores and/or transmits) information in a form readable by a machine (e.g., a wagering game machine, computer, etc.). For example, tangible machine-readable media includes read only memory (ROM), random access memory (RAM), magnetic disk storage media, optical storage media, flash memory machines, etc. Machine-readable media also includes any media suitable for transmitting software over a network.

### Example Operations

This section describes operations associated with some embodiments. In the discussion below, some flow diagrams are described with reference to block diagrams presented herein. However, in some embodiments, the operations can be performed by logic not described in the block diagrams.

In certain embodiments, the operations can be performed by executing instructions residing on machine-readable media (e.g., software), while in other embodiments, the operations can be performed by hardware and/or other logic (e.g., firmware). In some embodiments, the operations can be performed in series, while in other embodiments, one or more of the operations can be performed in parallel. Moreover, some embodiments can perform more or less than all the operations shown in any flow diagram.

FIG. 4 is a flow diagram illustrating generating and integrating overlay objects on a video feed in a wagering game, according to some embodiments. In FIG. 4, the flow 400 begins at processing block 402, where a wagering game system (“system”) receives a video feed. As described previously, the system can receive the video feed from various sources, including, but not limited to, television broadcast stations, casino generated video studios, and/or storage devices that store pre-recorded video feeds.

The flow 400 continues at processing block 404, where the system detects video items on the video feed. The system can detect the location of video items, or in other words, detect the position of items that appear on the video feed. For example, the system can determine a background on the video feed by its relative position behind all other items, by its uniformity of color or texture (e.g., sky, grass, a wall, etc.), or by other detection means. The system can then determine the items in front of the background. The system can determine the size of items by detecting the outline of their shape, texture, color, or other physical appearances. The system can also detect whether an item is moving and/or performing a specific activity (e.g., jumping, waving, swinging, talking, etc.).

The flow 400 continues at processing block 406, where the system generates overlay objects to use in a wagering game. The system can generate the overlay objects as images that can be used to highlight areas of the video feed that are playable elements of the wagering game. The system can generate the overlay objects to appear as geometric shapes, like boxes, circles, etc., similar to the overlay objects 115, 127 in FIG. 1. The geometric shapes can highlight the outline shape of video items. The system can utilize the video items' physical appearances to generate similar looking overlay objects. The system can generate the overlay objects to look like animations of the actual video items on the video feed. The system can also generate overlay objects to be transparent and/or have varying degrees of opacity. The system can also generate overlay objects that do not correspond to actual video items, but that may fit a theme of the video feed. For instance, in FIG. 1, the system 100 generated an object 127 that looked like a golf cart. The golf cart object 127 was not a video item in the original broadcast, but the system 100 generated the overlay object and incorporated it onto the video feed to match the golf theme. The system may need to generate additional overlay objects to create a sufficient number of objects needed for a game play. The system can also analyze activity and/or themes in the video feed and generate overlay objects that appear to fit the theme or activity of the video feed.

The flow 400 continues at processing block 408, where the system presents the overlay objects with the video feed. For example, the system can superimpose the overlay objects onto the video feed. In some embodiments, the system can generate a computerized grid. The computerized grid can be hidden from view, and can be a framework onto which the system can impose the overlay objects. The system can couple the video feed to the grid (e.g., impose the grid over the video feed or impose the video feed over the grid). The system can insert the overlay objects onto the grid. If an overlay object correlates to a video item, the system can position the overlay object to appear in the same location as the corresponding video item on the video feed. More specifically, in some embodiments, the system can generate the computerized grid to be scaled to dimensions of the video feed that confine the images and activities that appear on the video feed. The dimensions can include a number of reference points positioned on the grid that correlate to the video feed's corners, center, etc. The system can determine the locations of any video items that appear on the video feed in relation to the dimensions of the video feed. For instance, if the dimensions of a video feed are determined to be a specific height and length, the system can determine a relative height, length, and position for the video items in relation to the dimensions (e.g., height, length, reference points, etc.) of the video feed. The system can generate object location identifiers for the video items on the grid according to the locations of the video items. The system can anchor the object location identifiers to the grid to correlate to video items. The object identifiers, once anchored, can move with the video items as the picture of the video feed moves or as the items move in relation to the video feed. The system can associate the video feed with the computerized grid so that the object identifiers coincide with the video items. The system can then position the overlay objects to coincide with the object location identifiers corresponding to the video items. In some embodiments, the system can utilize pattern recognition algorithms to identify video items and superimpose overlay objects that track the movement and position of the video items. In some embodiments, the system can delay the video feed momentarily so that the pattern recognition process can generate and position overlay objects. The overlay objects can appear as borders (e.g., dotted borders, darkened lines, etc.) that surround or conform to the shapes of video items. The overlay objects can also be highlight effects (e.g., a glow, a sparkle, an animation, etc.) that appear to emanate from, surround, or conform to the shape of video items. An overlay object can indicate portions of the video feed that can be utilized as wagering game elements. The system can also present overlay objects according to player preferences. For example, the system can include preference settings in the player account that allow the player to indicate how overlay objects should appear (e.g., a border instead of a highlight effect, with a specific color, etc.) The system can also analyze activity and/or themes in the video feed and present the overlay objects so that they appear to fit the theme or activity of the video feed. In some embodiments, the system can present hidden overlay objects that respond to player instructions or wagering game instructions. For example, hidden overlay objects can appear on the wagering game machine display and the system can detect a selection of a control on the screen to begin the wagering game. The system can then cause some, or all, of the hidden overlay objects to appear on the screen.

The flow 400 continues at processing block 410, where the system processes the overlay objects as wagering game elements. For example, the system could detect that a player selects (e.g., touches) an overlay object. When the player selects the object, the system could display the value of the selected object. The value could be a “win” value, a “loss” value, a “dollar” or “credit” value, a game instruction, etc. In other examples, the system can cause the objects to move, spin, or otherwise process automatically, without player selection or intervention. For instance, the system could cause the overlay objects to cycle through images, like a slot reel, and stop on a slot reel outcome configuration (e.g., if three golf balls appear on the cycled images when they stop, the game results in a win). In some embodiments, the system can utilize the overlay objects as informational messages. For example, the system can display statistics, biographical information, email messages, advertisements, coupons, or any other information that may be of interest to a casino patron that is looking at the video feed on the display screen. The system can customize the information displayed via the overlay objects to the particular player account that is logged in to a wagering game machine. For example, the overlay object could indicate a player score, a social-contacts' avatar, etc.

FIG. 5 is a flow diagram illustrating generating and presenting wagering game scenarios that emulate activity from a video feed, according to some embodiments. In FIG. 5, the flow 500 begins at processing block 502, where a wagering game system (“system”) presents a video feed on a wagering game machine display. The system can receive a video feed and present the feed on the display screen of a wagering game machine

The flow 500 continues at processing block 504, where the system generates a wagering game scenario that relates to activity in the video feed and presents the wagering game scenario on the wagering game machine display. The system can track activity that occurs on the video feed and find a stopping point in activity. For example, if the activity is a television game show, the system can track a game show player's turn and determine when the player has completed the turn. If the activity is a sporting event, the system can determine when one or more athletes have completed their possession or playing turn. The system can determine activities presented by groups of players and determine appropriate times in the activity to allow a wagering game player to play a wagering game based on the activity. In some embodiments, the video feed may not be related to a game, but could be any event, such as a television sit-com, a movie drama, a personal video, etc. The system can still determine stopping points in the activity where a wagering game can be presented. The system can then pause the video feed at the stopping point. If the video feed is live, the system can record the video feed in the background. The system can store recorded video feeds on the server until needed. The system can then generate a wagering game scenario that mimics, adds to, follows, or in some other way emulates the activity in the video feed. The system can also generate themes displayed in the video feed (e.g., colors, patterns, etc.) and apply the theme to the wagering game scenario. For example, the system may detect video items, such as the background sets, logos, game play objects (e.g., game consoles, spinning wheels, etc.), hosts' or players' appearances, etc., and use images of those video items, and/or create simulated objects that look like the video items. The system can present the wagering game scenario in a wagering game. Presenting the wagering game scenario, for example, could include incorporating wagering game elements that perform similar activities as the activity in the video feed, overlaying wagering game elements onto the video feed or selected frames from the video feed, utilizing imagery from the video feed to present wagering game elements, etc.

The flow 500 continues at processing block 506, where the system tracks wagering game activity. For example, the system can detect the actions (e.g., wins, spins, transactions, etc) of a wagering game. The actions can be performed by a wagering game player, by the system, or both. The system can generate and/or store metadata related to the actions. Some of those actions may include, but are not limited to, calculating game results statistics, calculating money earned, movements of avatars on the screen, activity of other competitors, etc. The system can also capture video or screen captures of the player's activity to use during the wagering game, during transition back to the video feed, or for later review.

The flow 500 continues at processing block 508, where the system integrates the wagering game activity with the video feed. For example, the system can generate scores, statistics, etc. of the wagering game player and the actors/players on the video feed and provide a combined display of the wagering game player statistics with the video feed broadcast statistics. In another example, the system can generate a computerized segue back to the activity performed at the stopping point of the video feed, present the computerized segue on the wagering game machine display, and then continue displaying the video feed. The system can resume presenting the video feed, whether live or recorded. The server can ensure continuity of the broadcast event by utilizing editing software and timing instructions that display important activities from the video feed (e.g., sports activity, game-show player's reactions, etc.), but that cut out non-important activities or distractions (e.g. commercials, commentary, etc.) from the video feed. The system can also modify the video feed and re-edit it to display something different than what actually happened on the video feed. For example, the system can make the player on the video feed appear to lose a game instead of win a game, etc. The system can re-edit the recorded video. The system can also reimage the video presentation with computerized imagery.

### Additional Example Embodiments

According to some embodiments, a wagering game system (“system”) can provide various example devices, operations, etc., to integrate video feeds into wagering games. The following non-exhaustive list enumerates some possible embodiments.
The system can incorporate overlay objects to be used in group wagering games, where multiple player accounts participate in the wagering games.
The system can generate a wagering game based on video showing geographic locations. The system can integrate games and other tasks for the wagering game player(s) to complete into the video showing the geographic locations. The system can integrate the video of the locations with wagering game objects that the player(s) can use to complete the tasks.
The system can broadcast the video feed as a background for a wagering game.
The system can create episodic wagering games using video. The episodes can be based on episodic television shows.
The system can generate a three-dimensional version of the video where a player can zoom into and out of the wagering game objects.
The system can present side-betting on activities performed by wagering game players with video based games (e.g., betting on who will sink the putt, etc.). The system can also present a live video broadcast of an event with a side-betting game to bet on the activities performed by the character or performers in the live video broadcast.
The system can determine a pay table for a video based game and generate a scaled version of the pay table. (e.g., for a video based game where contestants win $10,000 for each successful activity, the system can scale the wagering game so that the wagering game player wins $10 for each equivalent successful wagering game result).
The system can re-present the video broadcast and provide a wagering game for the wagering game player to play in place of the video-broadcast player or along with the video-broadcast player (e.g., competing against Tiger Woods as he plays his 10 best holes based on past footage of his play).
The system can generate wagering games based on sporting events, reality television shows, game shows, or any other television event that has a competitive activity. However, the system can generate wagering games based on any television, movie, or other video broadcast, even without having a competitive nature. The system can also provide an interface for a player to upload personal videos. The system can integrate wagering game objects with the player's personal videos to generate a video based wagering game using the personal videos.
The system can utilize various devices in conjunction with video based wagering games, such as top boxes, peripheral display devices, virtual reality gear, etc.
The system can incorporate augmented reality of a video feed showing footage of a videographer walking around a location. The system can broadcast the video feed to hand-held devices that the wagering game players can utilize. As the player moves around a room with the hand-held device, the image of the video feed can moves accordingly. The system can detect the devices movements, and present an equivalent movement using the video feed. The system can present various wagering games throughout the augmented reality experience. The system can show virtual objects incorporated into the video feed, such as overlay objects (e.g., reels, buttons, flashing images, etc.) for the wagering game player to interact with. The system can detect a group vote on what topic, item, scene, location, or other activity or item is presented within the video feed.
The system can provide a poker event where multiple players can compete. The system can broadcast a video of the poker event and the players can participate as video based game players.
The system can broadcast the same video based games to multiple casinos using the same video feed.
The system can broadcast the video based games on the internet or on network browsing applications.
The system can detect when certain activities occur in the video feed and adjust the wagering game accordingly. For example, the system can present a video feed of a baseball game, and each time a baseball player hits a home run, the system can add money to a bonus game or jackpot.
The system can blend together events from multiple video feeds into a single conglomerated media presentation.
The system can provide controls and settings that permit players to create their own participating characters or devices (e.g., for a video based wagering game of a car race, the system can permit the player to build their own race car with which to compete).

### Additional Example Operating Environments

This section describes example operating environments, systems and networks, and presents structural aspects of some embodiments.

### Wagering Game Machine Architecture

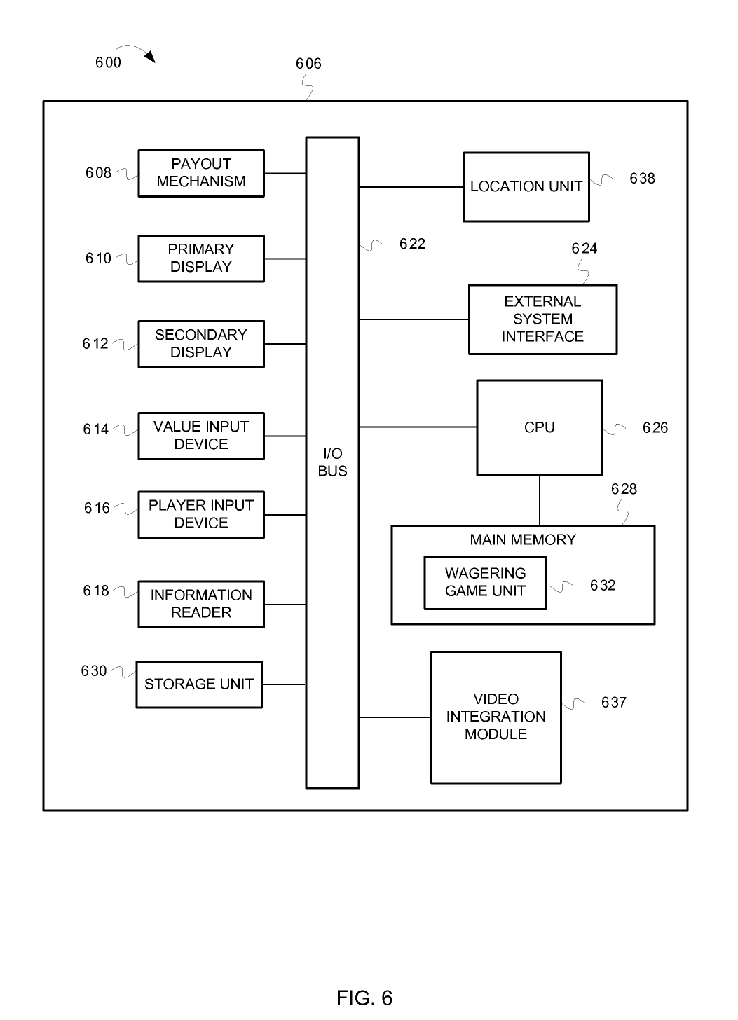

FIG. 6 is a conceptual diagram that illustrates an example of a wagering game machine architecture 600, according to some embodiments. In FIG. 6, the wagering game machine architecture 600 includes a wagering game machine 606, which includes a central processing unit (CPU) 626 connected to main memory 628. The CPU 626 can include any suitable processor, such as an Intel® Pentium processor, Intel® Core 2 Duo processor, AMD Opteron™ processor, or UltraSPARC processor. The main memory 628 includes a wagering game unit 632. In some embodiments, the wagering game unit 632 can present wagering games, such as video poker, video black jack, video slots, video lottery, reel slots, etc., in whole or part.

The CPU 626 is also connected to an input/output (“I/O”) bus 622, which can include any suitable bus technologies, such as an AGTL+frontside bus and a PCI backside bus. The I/O bus 622 is connected to a payout mechanism 608, primary display 610, secondary display 612, value input device 614, player input device 616, information reader 618, and storage unit 630. The player input device 616 can include the value input device 614 to the extent the player input device 616 is used to place wagers. The I/O bus 622 is also connected to an external system interface 624, which is connected to external systems 604 (e.g., wagering game networks). The external system interface 624 can include logic for exchanging information over wired and wireless networks (e.g., 802.11g transceiver, Bluetooth transceiver, Ethernet transceiver, etc.)

The I/O bus 622 is also connected to a location unit 638. The location unit 638 can create player information that indicates the wagering game machine's location/movements in a casino. In some embodiments, the location unit 638 includes a global positioning system (GPS) receiver that can determine the wagering game machine's location using GPS satellites. In other embodiments, the location unit 638 can include a radio frequency identification (RFID) tag that can determine the wagering game machine's location using RFID readers positioned throughout a casino. Some embodiments can use GPS receiver and RFID tags in combination, while other embodiments can use other suitable methods for determining the wagering game machine's location. Although not shown in FIG. 6, in some embodiments, the location unit 638 is not connected to the I/O bus 622.

In some embodiments, the wagering game machine 606 can include additional peripheral devices and/or more than one of each component shown in FIG. 6. For example, in some embodiments, the wagering game machine 606 can include multiple external system interfaces 624 and/or multiple CPUs 626. In some embodiments, any of the components can be integrated or subdivided.

In some embodiments, the wagering game machine 606 includes a video integration module 637. The video integration module 637 can process communications, commands, or other information, where the processing can integrate video feeds into wagering games.

Furthermore, any component of the wagering game machine 606 can include hardware, firmware, and/or machine-readable media including instructions for performing the operations described herein.

### Mobile Wagering Game Machine

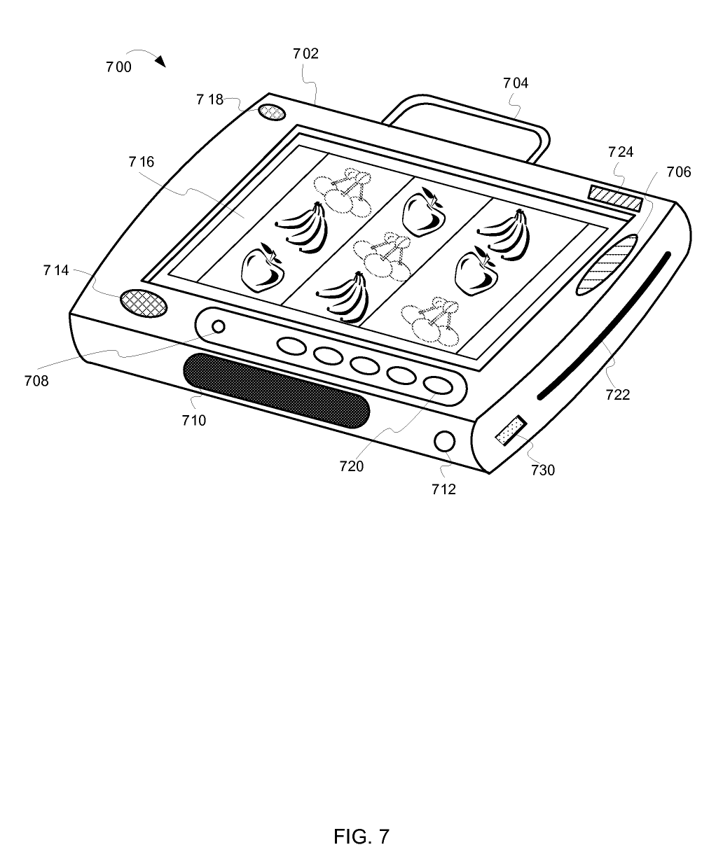

FIG. 7 is a conceptual diagram that illustrates an example of a mobile wagering game machine 700, according to some embodiments. In FIG. 7, the mobile wagering game machine 700 includes a housing 702 for containing internal hardware and/or software such as that described above vis-à-vis FIG. 6. In some embodiments, the housing has a form factor similar to a tablet PC, while other embodiments have different form factors. For example, the mobile wagering game machine 700 can exhibit smaller form factors, similar to those associated with personal digital assistants. In some embodiments, a handle 704 is attached to the housing 702. Additionally, the housing can store a foldout stand 710, which can hold the mobile wagering game machine 700 upright or semi-upright on a table or other flat surface.

The mobile wagering game machine 700 includes several input/output devices. In particular, the mobile wagering game machine 700 includes buttons 720, audio jack 708, speaker 714, display 716, biometric device 706, wireless transmission devices 712 and 724, microphone 718, and card reader 722. Additionally, the mobile wagering game machine can include tilt, orientation, ambient light, or other environmental sensors.

In some embodiments, the mobile wagering game machine 700 uses the biometric device 706 for authenticating players, whereas it uses the display 716 and speakers 714 for presenting wagering game results and other information (e.g., credits, progressive jackpots, etc.) The mobile wagering game machine 700 can also present audio through the audio jack 708 or through a wireless link such as Bluetooth.

In some embodiments, the wireless communication unit 712 can include infrared wireless communications technology for receiving wagering game content while docked in a wager gaming station. The wireless communication unit 724 can include an 802.11G transceiver for connecting to and exchanging information with wireless access points. The wireless communication unit 724 can include a Bluetooth transceiver for exchanging information with other Bluetooth enabled devices.

In some embodiments, the mobile wagering game machine 700 is constructed from damage resistant materials, such as polymer plastics. Portions of the mobile wagering game machine 700 can be constructed from non-porous plastics which exhibit antimicrobial qualities. Also, the mobile wagering game machine 700 can be liquid resistant for easy cleaning and sanitization.

In some embodiments, the mobile wagering game machine 700 can also include an input/output (“I/O”) port 730 for connecting directly to another device, such as to a peripheral device, a secondary mobile machine, etc. Furthermore, any component of the mobile wagering game machine 700 can include hardware, firmware, and/or machine-readable media including instructions for performing the operations described herein.

The described embodiments may be provided as a computer program product, or software, that may include a machine-readable medium having stored thereon instructions, which may be used to program a computer system (or other electronic device(s)) to perform a process according to embodiments(s), whether presently described or not, because every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

### General

This detailed description refers to specific examples in the drawings and illustrations. These examples are described in sufficient detail to enable those skilled in the art to practice the inventive subject matter. These examples also serve to illustrate how the inventive subject matter can be applied to various purposes or embodiments. Other embodiments are included within the inventive subject matter, as logical, mechanical, electrical, and other changes can be made to the example embodiments described herein. Features of various embodiments described herein, however essential to the example embodiments in which they are incorporated, do not limit the inventive subject matter as a whole, and any reference to the invention, its elements, operation, and application are not limiting as a whole, but serve only to define these example embodiments. This detailed description does not, therefore, limit embodiments, which are defined only by the appended claims. Each of the embodiments described herein are contemplated as falling within the inventive subject matter, which is set forth in the following claims.

1. A computer-implemented method comprising:
presenting a video feed that depicts a player's performance of a play during a sporting event;
pausing the presenting of the video feed after the player's performance of the play but before presenting a depiction of a play outcome that results from the player's performance of the play;
receiving a wager on whether the player's performance of the play results in the play outcome;
randomly determining to present one of either the depiction of the play outcome or a depiction of a different possible outcome;
presenting, after receiving the wager, the one of either the depiction of the play outcome or the depiction of the different possible outcome; and
processing the wager based on the randomly determining

2. The computer-implemented method of claim 1, wherein the video feed is any one or more of a live television broadcast, a recorded television broadcast, and an internet broadcast.

3. The computer-implemented method of claim 1, wherein detecting the video feed game activity comprises:
determining one or more of game rules, video themes, item movements, and statistics related to the sporting event; and
generating a virtual wagering game scenario in which to present the one of either the depiction of the play outcome or the depiction of the different possible outcome, wherein the wagering game scenario appears and behaves in compliance with the one or more of game rules, video themes, item movements, and statistics related to the sporting event.

4. The computer-implemented method of claim 1, further comprising:
generating a virtual wagering game scenario that emulates the sporting event;
generating a virtual wagering game character configured to emulate characteristics of a player in the sporting event;
presenting the virtual wagering game character in the virtual wagering game scenario to emulate an appearance of the player during the player's performance; and
presenting the virtual wagering game character performing the one of either the depiction of the play outcome or the depiction of the different possible outcome.

5. The computer-implemented method of claim 4, wherein the randomly determining to present one of either the depiction of the play outcome or a depiction of a different possible outcome includes determining to present the depiction of the play outcome and further comprising resuming the presenting of the video feed to reveal a video-recorded depiction of the play outcome.

6. The computer-implemented method of claim 1, further comprising:
determining a point or reward amount associated with the play; and
presenting a wager payout that is proportional to the point or reward amount.

7. One or more machine-readable media having instructions stored thereon, which when executed by a set of one or more processors causes the set of one or more processors to perform operations comprising:
receiving a video feed that includes depictions of graphical items that appear within the video feed;
detecting locations at which the depictions of the graphical items appear in relation to a frame of the video feed;
generating overlay graphics to be positioned on the video feed in association with the depictions of the graphical items;
presenting the overlay graphics and the video feed on a display with the overlay graphics superimposed, at the locations, on the video feed; and
using the overlay graphics as the wagering game elements in a wagering game, wherein the wagering game elements reveal an outcome for the wagering game.

8. The machine-readable media of claim 7, wherein the video feed is any one of more of a live television broadcast, a recorded video broadcast, an Internet video feed, and a casino generated video feed.

9. The machine-readable media of claim 7, said generating the overlay graphics further comprising:
detecting shapes of the depictions of the graphical items that appear on the video feed; and
generating the overlay graphics to conform to the shapes of the depictions of the graphical items.

10. The machine-readable media of claim 7, wherein the overlay graphics can be any one or more of an animation, an outline, a border, a visual effect, and a virtualized object.

11. The machine-readable media of claim 7, said generating the overlay graphics further comprising:
accessing a player account with a player preference for displaying the overlay graphics; and
presenting the overlay graphics according to the player preference.

12. The machine-readable media of claim 7, further comprising:
determining a wagering game outcome for the wagering game, wherein the wagering game outcome is associated with a specific display layout of a specific number of game related images as indicated by a pay table for the wagering game, and wherein the pay table specifies a given reward payout for the specific display layout of the specific number of game related images;
generating a number of the graphical overlay objects that is at least the specific number of game related images associated with the wagering game outcome;
selecting the locations of the depictions of the graphical images so that a dimensional position of the locations in relation to the frame of the video feed coincides with the specific display layout associated with the wagering game outcome; and
presenting the overlay graphics as the game related images superimposed at the locations in the specific display layout.

13. A system comprising:
a video feed integrator configured to
receive a video feed that includes depictions of graphical items,
detect locations at which the depictions of the graphical items appear in relation to a frame of the video feed,
generate overlay graphics to be positioned on the video feed in association with the depictions of the graphical items;
a video integration module configured to
present the overlay graphics and the video feed on a wagering game machine display with the overlay graphics superimposed, at the locations, on video feed; and
a content controller configured to
use the overlay graphics in a wagering game, wherein the wagering game elements reveal an outcome for the wagering game.

14. The system of claim 13, wherein the video feed integrator is further configured to generate a virtual character configured to emulate game activity of a video-recorded character depicted in the video feed.

15. The system of claim 13, wherein the video feed integrator is further configured to
detect thematic elements of the video feed, and
generate the wagering game elements to conform to the thematic elements in any one or more of behavior and appearance.

16. The system of claim 13, wherein the overlay graphics include a visible border and wherein the video integration module is further configured to superimpose the visible border of the overlay graphics in a way that surrounds the locations of the depictions of the items to highlight that the locations of the depictions of the items are selectable as the wagering game elements

17. The system of claim 13, wherein the content controller is further configured to
detect an initiation of a wagering game playing activity,
change the appearance of the overlay graphics to appear as images that are associated with a pay table for the wagering game,
generate a wagering game outcome that coincides with a specific display layout of the images, and
reveal the wagering game outcome using the overlay graphics to present the specific display layout of the images.

18. The system of claim 12, further comprising:
an account server configured to
invite player accounts to participate in the wagering game, and
store player preferences regarding how the wagering game playing elements are presented.

19. An apparatus, comprising:
a video integration module configured to
receive a video feed that includes depictions of graphical items that appear during a recording of a non-wagering game event,
detect locations at which the depictions of the graphical items appear in relation to a frame of the video feed,
detect thematic visual characteristics of the depictions of the graphical items in the video feed,
generate overlay graphics that conform to the thematic visual characteristics in appearance,
present the video feed and the overlay graphics on a wagering game display with the overlay graphics superimposed on top of the locations to highlight the locations on the video feed as the wagering game elements of the wagering game,
detect selection of one of the overlay graphics via user input,
determine a wager associated with the selection of the one of the overlay graphics, and
present a wagering game outcome, based on the wager, using the one of the overlay graphics.

20. The apparatus of claim 19, wherein the video integration module is further configured to,
determine a background of the video feed in relation to the position of the depictions of the graphical items,
detect any one or more of shapes, patterns, and movements of the depictions of the graphical items, and
use the one or more of the shapes, patters, and movements to generate the overlay graphics.

21. The apparatus of claim 19, wherein the video integration module is further configured to,
determine a first number of the wagering game elements needed to process the wagering game, according to wagering game logic, and
generate a second number of the overlay graphics that is equal to or more than the first number.

22. The apparatus of claim 19, wherein the video integration module is further configured to generate the overlay graphics to include any one or more of an animation similar to the appearance of the depictions of the graphical items, an outline effect surrounding the depictions of the graphical items, and a visual effect emanating from the depictions of the graphical items.

23. The apparatus of claim 19, wherein the video integration module is further configured to recognize positional patterns of the graphical items in context of the frame of the video feed and tracking grid coordinates of the positional patterns.

24. An apparatus, comprising:
means for displaying a presentation of a television broadcast feed on a wagering game machine display, wherein the television broadcast feed depicts a video-recorded character that performs a player's portion of a playing turn of a non-wagering game;
means for pausing the presentation of the television broadcast feed on the wagering game machine display before presenting a playing turn outcome that occurs because of the player's portion of the playing turn, wherein the playing turn outcome is one of either a successful outcome for the playing turn or an unsuccessful outcome for the playing turn;
means for receiving a wager on whether the playing turn outcome will be the successful outcome or the unsuccessful outcome;
means for resuming the presentation of the television broadcast feed on the wagering game machine display revealing the playing turn outcome after receiving the wager; and
means for processing the wager based on the playing turn outcome.

25. The apparatus of claim 24, wherein the means for resuming the presentation of the television broadcast feed further comprises,
means for generating a virtual character,
means for presenting the virtual character over the television broadcast feed in place of the video-recorded character after resuming the presentation of the television broadcast feed, and
revealing the playing turn outcome using the virtual character.
